(19) United States
(12) Patent Application Publication
(10) Pub. No.: US 2016/0237289 A1
(43) Pub. Date: Aug. 18, 2016

(54) COMPOSITION OF COATING SOLUTION AND DYE SOLVENT USED IN INFORMATION RECORDING MEDIA

(71) Applicant: FU-SHING WANG, Taoyuan City (TW)

(72) Inventor: FU-SHING WANG, Taoyuan City (TW)

(21) Appl. No.: 15/013,265

(22) Filed: Feb. 2, 2016

Related U.S. Application Data
(60) Provisional application No. 62/117,060, filed on Feb. 17, 2015.

(51) Int. Cl. C09D 7/00

(52) U.S. Cl. CPC C09D 7/001; C09D 7/007

(57) ABSTRACT

The present invention provides a composition of dye solvent used in an information recording media, comprising: a fluorinated alcohol having a chemical formula of R¹(CFR²CF₂)ₙCH₂OH; wherein n is 0, 1, or 2; R¹ represents HCF₂ or CF₃ when n is 0; R¹ represents H, F or CF₃ and R² represents H, F or CF₃ when n is 1; and R¹ represents H, F or CF₃ and R² represents F when n is 2; and an organic solvent comprising at least one of the following: alcohols, alcohol ethers, ethers, ether esters, alcohol esters, alcohol ketones, esters, ketones, keto esters, acyl amines, and pyrrolidones.

### FIELD OF THE INVENTION

The present invention is related to a composition of coating solution of information recording media, especially related to a composition of dye solvent used in formation of recording layer of information recording media.

### BACKGROUND OF THE INVENTION

With the progress of science and technology, more demands on enjoyments for higher technologies, such as high-speed Internet and high resolution videos are widespread. In addition, high definition television (HDTV) is recently invented and requirements on manufacturing a low-cost information recording media with large storage space are also increased. Nowadays, it is very common that using Compact Disc-Recordable (CD-R) and Digital Versatile Disc Recordable (DVD-R) as recording medias to perform high-density recording by laser beam (630-680 nm).

In a disc manufacturing process, a conventional method is to use low-cost plastic material for a substrate, and then forming a reflective layer, a recording layer, a protective layer, and etc. Formation of the recording layer requires a solvent which is capable to dissolve dyes, and it is optional to mix with adhesive agent, antioxidant, UV absorbing agent, plasticizer, light stabilizer, lubricant, and so on depending on different cases. Then the solution containing the dyes is coated on the substrate and dried to form the recording layer. In order to have signal accuracy and high product quality, it is necessary the solvent used in manufacturing DVD-R has limited damage to depths and widths of grooves of the substrate, capability to dissolve dyes and character of proper volatilization rate. However, solubilities of conventional dyes and other solutes, such as abovementioned light stabilizer, are very low in common choices of organic solvents, which have limited damages to a plastic substrate. Conventionally, tetrafluoropropanol is used as the only solvent to dissolve dyes and other solutes in the manufacturing process.

Although dissolvability of tetrafluoropropanol is better relatively to other organic solvents, the price of tetrafluoropropanol is very high. It is not just monopolized in the market but also has low volatilization rate on a resin substrate. In the manufacturing process, a drying process requires to be performed under a baking temperature of at least 80° C. in order to volatilize to dry, and it increases cost of manufacturing time, manpower, electricity, and overall manufacturing budget. Hence, how to improve volatilization rate of dye-containing solution, lower baking temperature of a coating layer on a polycarbonate resin substrate, and keep qualities of information storage abilities and good dissolvabilities to DVD-R dyes and light stabilizer in the meanwhile becomes purposes of the present invention in order to improve manufacturing productivity without sacrifice on product quality.

### SUMMARY OF THE INVENTION

In an aspect of the present invention, it provides a composition of dye solvent used in an information recording media, comprising: a fluorinated alcohol having a chemical formula of R¹(CFR²CF₂)ₙCH₂OH; wherein n is 0, 1, or 2; R¹ represents HCF₂ or CF₃ when n is 0; R¹ represents H, F or CF₃ and R² represents H, F or CF₃ when n is 1; and R¹ represents H, F or CF₃ and R² represents F when n is 2; and an organic solvent comprising at least one of the following: alcohols, alcohol ethers, ethers, ether esters, alcohol esters, alcohol ketones, esters, ketones, keto esters, acyl amines, and pyrrolidones.

In one embodiment of the present invention, wherein a weight percentage of the fluorinated alcohol to the dye solvent is in a range of 5 wt % and 99 wt %.

In one embodiment of the present invention, wherein a boiling point of the organic solvent is in a range of 50° C.-280° C.

In one embodiment of the present invention, wherein the organic solvent is selected from at least one of the following group: methanol, ethanol, propanol, isopropanol, butanol, 2-butyl alcohol, 3 -methyl-3 -methoxybutanol, 1-pentanol, 2-pentanol, 3-pentanol, 2-methyl-2-butanol, 2-methyl-1-butanol, 2-methoxyethanol, 2-ethoxyethanol, 2-trifluoroethoxyethanol(CF₃CH₂OCH₂CH₂OH), 2-[2,2′,3,3′-tetrafluoro-propoxy]-ethanol(HCF₂CF₂O-CH₂CH₂OH), ethylene methyl ether acetate, 1-methoxy-2-propanol, 1-ethoxy-2-propanol, CF₃CH₂OCH₂CH₂CH₂OH, propylene glycol methyl ether acetate, ethyl acetate, ethyl trifluoroacetate, butyl acetate, CF₃CFHCF₂CH₂OCOCH₃, CH₃OCOCH₂OH, CF₃CH₂OCOCH₂OH, HCF₂CF₂CH₂OCOCH₂OH, CF₃CFHCF₂CH₂OCOCH₂OH, 4-hydroxy-4-methyl-2-pentanone, N,N-dimethylaniline, dimethyl carbonate, diethyl carbonate, (CF₃CH₂O)₂CO, (HCF₂CF₂CH₂O)₂CO, (CF₃CFHCF₂CH₂O)₂CO, dipropyl carbonate, diethyl lactate, ethyl lactate, trifluoroethyl lactate, CF₃CFHCF₂CH₂OCOCHOHCH₃, methyl-2-pyrrolidone, trifluoroethyl pyrrolidone and tetrafluoropropyl pyrrolidone.

In one embodiment of the present invention, the method further comprises.

In another aspect of the present invention, it provides a composition of coating solution used in an information recording media, comprising: a dye solvent as described above; and a dye, selected from at least one of the following group: cyanine dyes, phthalocyanine dyes, azo dyes, quinine dyes, ammonium-based dyes, diimine dyes, metal complex salt dyes, pyrazole pyrylium dyes, and thiopyrylium dyes.

Accordingly, the present invention provides compositions of solvent and solution used in formation of the coating layer for forming the recording layer applied in information recording media in order to reduce usage of tetrafluoropropanol or even replace usage of tetrafluoropropanol without unfavorable impact on product performance and qualities and thus to solve problems of low volatilization rate and high cost on material and manufacturing budget in the conventional manufacturing process.

### DETAILED DESCRIPTION OF PREFERRED EMBODIMENTS

The present invention provides compositions of solvent and solution used in formation of the coating layer for forming the recording layer applied in information recording media. The purposes of the present invention is to reduce usage of tetrafluoropropanol or even replace usage of tetrafluoropropanol under a condition of none or limited damages to the substrate and high dissolvability to dyes and other solutes. Thus, the present invention can solve problems of difficulties and high coast in drying process in conventional manufacturing process by improvement of volatilization rates and reduction drying temperature.

It is to be noted that the following descriptions of preferred embodiments of this invention are presented herein for purpose of illustration and description only but not intended to be exhaustive or to be limited to the precise form disclosed.

In the following illustration, the element arranged repeatedly is described in word “one”, “a” or “an” for simpler explanation. However, one skilled in the art should understand the practical structure and arrangement of each element based on the following illustration and figures provided in the present application. In addition, word “room temperature” used in the following illustration refers to temperatures in a range of 20° C.-40° C., and more specifically 20° C.-30° C.

Moreover, in the following illustration, word “solvent composition” described herein represents one chemical or a mixture of chemicals used as solvent to dissolve dyes in formation of a recording layer; word “dye composition” described herein represents one dye or a mixture of dyes used in formation of a recording layer; word “dye-solvent solution” described herein represents mixture of the dye composition and the solvent composition; and word “coating solution” describe herein represents the dye-solvent solution after filtration process and before drying into a information recording layer.

The present invention provides a solvent composition of an information recording media comprising: a fluorinated alcohol having a chemical formula of R¹(CFR²CF₂)ₙCH₂OH; and an organic solvent comprising at least one of the following: alcohols, alcohol ethers, ethers, ether esters, alcohol esters, alcohol ketones, esters, ketones, keto esters, acyl amines, and pyrrolidones. Wherein n is 0, 1, or 2; R¹ represents HCF₂ or CF₃ when n is 0; R¹ represents H, F or CF₃ and R² represents H, F or CF₃ when n is 1, and R′ represents H, F or CF₃ and R² represents F when n is 2. A weight percentage of the fluorinated alcohol to the solvent composition is in a range of 5 wt % and 99 wt %. A boiling point of the organic solvent is in a range of 50° C.-280° C., and the organic solvent can be at least one of the following: methanol, ethanol, propanol, isopropanol, butanol, 2-butyl alcohol, 3-methyl-3-methoxybutanol, 1-pentanol, 2-pentanol, 3-pentanol, 2-methyl-2-butanol, 2-methyl-1-butanol, 2-methoxyethanol, 2-ethoxyethanol, 2-trifluoroethoxyethanol(CF₃CH₂OCH₂CH₂OH), 2-[2,2′,3,3′-tetrafluoro-propoxy]-ethanol(HCF₂CF₂O—CH₂CH₂OH), ethylene methyl ether acetate, 1-methoxy-2-propanol, 1-ethoxy-2-propanol, CF₃CH₂OCH₂CH₂CH₂OH, propylene glycol methyl ether acetate, ethyl acetate, ethyl trifluoroacetate, butyl acetate, CF₃CFHCF₂CH₂OCOCH₃, CH₃OCOCH₂OH, CF₃CH₂OCOCH₂OH, HCF₂CF₂CH₂OCOCH₂OH, CF₃CFHCF₂CH₂OCOCH₂OH, 4-hydroxy-4-methyl-2-pentanone, N,N-dimethylaniline, dimethyl carbonate, diethyl carbonate, (CF₃CH₂O)₂CO, (HCF₂CF₂CH₂O)₂CO, (CF₃CFHCF₂CH₂O)₂CO, dipropyl carbonate, diethyl lactate, ethyl lactate, trifluoroethyl lactate, CF₃CFHCF₂CH₂OCOCHOHCH₃, methyl-2-pyrrolidone, trifluoroethyl pyrrolidone and tetrafluoropropyl pyrrolidone.

The above illustrated solvent composition of an information recording media is to dissolve dyes in order to be coated onto a grooved substrate and form a recording layer. For easier understanding only, the solvent composition is applied in a DVD-R manufacturing process in each of the following embodiments to illustrate its effectiveness. In the following embodiments, the substrates are made by resin, such as polycarbonate resin, acrylate resin, polycycloalkenes (COC), and polyester resin, and have spiral grooves formed thereon. The recording layer is formed on the substrate to make DVD-R capable to record/write/copy information via laser beam with a certain range of wave length. And a dye composition used in the recording layer includes at least one of the following: cyanine dyes, phthalocyanine dyes, azo dyes, quinine dyes, ammonium-based dyes, diimine dyes, metal complex salt dyes, pyrazole pyrylium dyes, and thiopyrylium dyes. It is noted that the following embodiment use DVD-R manufacturing process for illustration but not intent to limit applications of the present invention.

In one embodiment of the present invention, N-propanol is used as an organic solvent and has a weight percentage of 60% to solvent composition. A fluorinated alcohol has a weight percentage of 40% to solvent composition, wherein the fluorinated alcohol includes 50 wt % of 2,2,2-trifluoroethanol, 40 wt % of 2,2,3,3-tetrafluoro-1-propanol, and 10 wt % of 2,2,3,4,4,4-hexafluoro-1-butanol. The solvent composition deployed following the above ratio has high dissolvability to cyanine dyes and none or very limited impact to the transparent substrate.

In this embodiment, two asymmetry cyanine dyes are used as major dyes. The two cyanine dyes are manufactured by Lianhetech Chemical Technology Co., Ltd. having trade names of Cyanine dye OD-800 and OD-05 respectively. A diimine dye is used as a secondary die and works as a light stabilizer. The diimine dye used in this embodiment is manufactured by Lianhetech Chemical Technology Co., Ltd., having a trade name Q-500. The dye composition includes major and secondary dyes and has a weight percentage of 0.9% to dye-solvent solution, wherein OD-800 has a weight percentage of 55% to dye composition, OD-05 has a weight percentage of 35% to dye composition, and the light stabilizer Q-500 has a weight percentage of 10% to dye composition. According the ingredients and the ratios above, application of the coating solution is illustrated as follows. Firstly, it is to mix 247.75 g of 2,2,2-trifluoroethanol, 198.2 g of 2,2,3,3-tetrafluoro-1-propanol, and 49.55 g of 2,2,3,4,4,4-hexafluoro-1-butanol together to form fluorinated alcohol composition. And asymmetry cyanine dyes including 4.95 g of OD-800 and 3.15 g of OD-05, and 0.9 g of diimine dye (as a light stabilizer) Q-500 respectively are added into the fluorinated alcohol composition to form fluorinated-alcohol-and-dye mixture. Then the fluorinated-alcohol-and-dye mixture is stirred for one hour under condition of 25° C. Afterward, 594.6 g of N-propanol is added into the fluorinated-alcohol-and-dye mixture stirring for 4 hours under condition of 25° C. to form the dye-solvent composition. The dye-solvent composition is then filtered through a filter with a pore size of 0.2 um to form the coating solution, wherein a filtration speed is 8200 rpm and a sprayed-out speed of filtered solution is 2.7 ml/sec. Then the coating solution is coated onto a polycarbonate resin transparent substrate; and sequentially, the coated substrate is baked to dry under a condition of 30° C. In addition, a change rate of top widths of the spiral groove (a top width between two sides of the spiral groove) before coating and after drying is 20% or below; and a change rate of depths of the spiral groove before coating and after drying is also 20% or below.

A drying temperature for the coating solution on the polycarbonate resin can be reduced from 80° C., as in conventional fabrication process, to 30° C. The reduction in drying temperature can lead to reduction in electricity demands for the drying process. And electricity cost can be reduced by around 100,000 New Taiwanese Dollar (NTD) per month after the inventor actually applied the solvent composition provided by the present invention into the manufacturing process.

In another embodiment of the present invention, N-propanol and diethyl carbonate are used as an organic solvent and have a weight percentage of 50% and 15% respectively to the solvent composition. A fluorinated alcohol has a weight percentage of 35% to the solvent composition, wherein the fluorinated alcohol includes 30 wt % of 2,2,2-trifluoroethanol and 5 wt % of 2,2,3,4,4,4-hexafluoro-1-butanol respectively to the solvent composition.

In this embodiment, two asymmetry cyanine dyes are used as major dyes. The two cyanine dyes are manufactured by Lianhetech Chemical Technology Co., Ltd. having trade names of Cyanine dye OD-800 and OD-05 respectively. A diimine dye is used as a secondary die and works as a light stabilizer. The diimine dye used in this embodiment is manufactured by Lianhetech Chemical Technology Co., Ltd. having a trade name Q-500. The dye composition includes major and secondary dyes and has a weight percentage of 0.8% to dye-solvent solution, wherein OD-800 has a weight percentage of 55% to dye composition, OD-05 has a weight percentage of 35% to dye composition, and the light stabilizer Q-500 has a weight percentage of 10% to dye composition. According the ingredients and the ratios above, application of the coating solution is illustrated as follows. Firstly, it is to mix 297.6 g of 2,2,2-trifluoroethanol, and 49.6 g of 2,2,3,3-tetrafluoro-1-propanol together to form fluorinated alcohol composition. And asymmetry cyanine dyes including 4.4 g of OD-800 and 2.8 g of OD-05, and 0.8 g of diimine dye (as a light stabilizer) Q-500 are respectively added into the fluorinated alcohol composition to form fluorinated-alcohol-and-dye mixture. Then the fluorinated-alcohol-and-dye mixture is stirred for one hour under condition of 25° C. Afterward, 496 g of N-propanol and 148.8 g of diethyl carbonate are added into the fluorinated-alcohol-and-dye mixture stirring for 4 hours under condition of 25° C. to form the dye-solvent composition. The dye-solvent composition is then filtered through a filter with a pore size of 0.2 um to form the coating solution, wherein a filtration speed is 8800 rpm and a spray-out speed of filtered solution is 3.0 ml/sec. Then the coating solution is coated onto a polycarbonate resin transparent substrate; and sequentially, the coated substrate is baked to dry under a condition of 25° C. in temperature. In addition, a change rate of top widths of the spiral groove (a top width between two sides of the spiral groove) before coating and after drying is 20% or below; and a change rate of depths of the spiral groove before coating and after drying is also 20% or below.

The above embodiments use dye solvent of the information recording media provided by the present invention, and a drying temperature in the dry process thus can be reduced from 80° C., as in conventional fabrication process, to 25° C. The reduction in drying temperature can lead to reduction in electricity demands for drying process. And electricity cost can be reduced by around 100,000 New Taiwanese Dollar (NTD) per month after the inventor actually applied the solvent composition provided by the present invention into the manufacturing process.

The compositions of solvent and solution used in formation of the coating layer of information recording medias provided by the present invention can reduce usage of tetrafluoropropanol or even replace usage of tetrafluoropropanol under a condition of none or limited damages to the substrate and also high dissolvability to dyes and other solutes. Thus, the present invention can solve problems of difficulties and high coast in drying process in conventional manufacturing process by improvement of volatilization rates and reduction drying temperature.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A composition of dye solvent used in an information recording media, comprising:
a fluorinated alcohol having a chemical formula of R¹(CFR²CF₂)ₙCH₂OH; wherein n is 0, 1, or 2; R¹ represents HCF₂ or CF₃ when n is 0; R¹ represents H, F or CF₃ and R² represents H, F or CF₃ when n is 1; and R′ represents H, F or CF₃ and R² represents F when n is 2; and
an organic solvent comprising at least one of the following: alcohols, alcohol ethers, ethers, ether esters, alcohol esters, alcohol ketones, esters, ketones, keto esters, acyl amines, and pyrrolidones.

2. The composition of dye solvent used in an information recording media according to claim 1, wherein a weight percentage of the fluorinated alcohol to the dye solvent is in a range of 5 wt % and 99 wt %.

3. The composition of dye solvent used in an information recording media according to claim 1, a boiling point of the organic solvent is in a range of 50° C.-280° C.

4. The composition of dye solvent used in an information recording media according to claim 1, wherein the organic solvent is selected from at least one of the following group: methanol, ethanol, propanol, isopropanol, butanol, 2-butyl alcohol, 3-methyl-3-methoxybutanol, 1-pentanol, 2-pentanol, 3-pentanol, 2-methyl-2-butanol, 2-methyl-1-butanol, 2-methoxyethanol, 2-ethoxyethanol, 2-trifluoroethoxyethanol(CF₃CH₂OCH₂CH₂OH), 2-[2,2′,3,3′-tetrafluoro-propoxy]-ethanol(HCF₂CF₂O—CH₂CH₂OH), ethylene methyl ether acetate, 1-methoxy-2-propanol, 1-ethoxy-2-propanol, CF₃CH₂OCH₂CH₂CH₂OH, propylene glycol methyl ether acetate, ethyl acetate, ethyl trifluoroacetate, butyl acetate, CF₃CFHCF₂CH₂OCOCH₃, CH₃OCOCH₂OH, CF₃CH₂OCOCH₂OH, HCF₂CF₂CH₂OCOCH₂OH, CF₃CFHCF₂CH₂O CO CH₂OH, 4-hydroxy-4-methyl-2-pentanone, N,N-dimethylaniline, dimethyl carbonate, diethyl carbonate, (CF₃CH₂O)₂CO, (HCF₂CF₂CH₂O)₂CO, (CF₃CFHCF₂CH₂O)₂CO, dipropyl carbonate, diethyl lactate, ethyl lactate, trifluoroethyl lactate, CF₃CFHCF₂CH₂OCOCHOHCH₃, methyl-2-pyrrolidone, trifluoroethyl pyrrolidone and tetrafluoropropyl pyrrolidone.

5. A composition of coating solution used in an information recording media, comprising:
a dye solvent according to claim 1; and
a dye, selected from at least one of the following group: cyanine dyes, phthalocyanine dyes, azo dyes, quinine dyes, ammonium-based dyes, diimine dyes, metal complex salt dyes, pyrazole pyrylium dyes, and thiopyrylium dyes.
